(19) United States
(12) Patent Application Publication
(10) Pub. No.: US 2016/0236712 A1
(43) Pub. Date: Aug. 18, 2016

(54) DRIVER STATE DETERMINATION SYSTEM

(71) Applicant: HONDA MOTOR CO., LTD., Tokyo (JP)

(72) Inventors: Tetsuro Shirakata, Wako-shi (JP); Naotaka Kumakiri, Wako-shi (JP); Hiroyuki Koike, Wako-shi (JP)

(21) Appl. No.: 15/042,320

(22) Filed: Feb. 12, 2016

(30) Foreign Application Priority Data
Feb. 16, 2015 (JP) 2015-027149

(51) Int. Cl. B62D 15/02

(52) U.S. Cl. CPC B62D 15/025; B62D 15/029

(57) ABSTRACT

A driver state determination system capable of accurately determining a state of vigilance of a driver, for a vehicle in which steering assist control is performed. The driver state determination system includes an ECU. The ECU performs LKAS control or normal control based on an ON/OFF state of an LKAS switch. During execution of the LKAS control, the ECU sets a vigilance level using a steering torque. During no-execution of the LKAS control, the ECU sets the vigilance level using a steering angle.

### BACKGROUND OF THE INVENTION

1. Field of the Invention

The present invention relates to a driver state determination system that determines a state of vigilance of a driver driving a vehicle.

2. Description of the Related Art

The present applicant has already proposed a driver state determination system disclosed in International Publication Pamphlet No. WO2011/040390 as a conventional driver state determination system. The driver state determination system determines a vigilance state of a driver driving a vehicle by a method described hereinafter.

In the case of the above driver state determination system, an azimuth angle difference which is a difference between a target azimuth angle and an actual azimuth angle is calculated, and an estimated steering angle is calculated using a discrete-time system model defining a relationship between the azimuth angle difference and a steering angle. Then, a mean square value of a difference between the estimated steering angle and an actual steering angle is calculated as a residual, and a normalized residual is calculated by dividing the residual by a square value of a steady-state gain. When the normalized residual is not smaller than a predetermined determination value, it is determined that the vigilance of the driver is in a low state (low vigilance state), and otherwise it is determined that the vigilance of the driver is in a high state (high vigilance state).

Further, the present applicant has already proposed a control system for a vehicle, as disclosed in Japanese Laid-Open Patent Publication (Kokai) No. 2011-51570. The control system performs lane-keeping assist control as steering assist control, and includes an electric power steering unit, a steering angle sensor, a yaw rate sensor, a lateral acceleration sensor, wheel speed sensors, and so forth. The lane-keeping assist control controls lane-keeping assist torque for assisting the driver to steer the vehicle such that the vehicle in a traveling state is caused to keep traveling along a travel lane in order to reduce driving load on a driver. In the lane-keeping assist control, the lane-keeping assist torque is calculated according to a steering angle, a yaw rate, a lateral acceleration, a vehicle speed, and so forth, and a motor of the electric power steering unit is controlled such that assist torque associated with the calculated lane-keeping assist torque and the steering angle of the driver is generated.

In a case where the above-described driver state determination system disclosed in International Publication Pamphlet No. WO2011/040390 is applied to a vehicle equipped with the above-described control system disclosed in Japanese Laid-Open Patent Publication (Kokai) No. 2011-51570, there is a fear that determination accuracy of the driver state determination system is lowered, as described hereafter. That is, the driver state determination system disclosed in International Publication Pamphlet No. WO2011/040390 uses, as described above, the method of determining a high or low vigilance state of the driver by comparing the normalized residual, which is calculated using the difference between the estimated steering angle and the actual steering angle, with the predetermined determination value. On the other hand, in the case where the lane-keeping assist control disclosed in Japanese Laid-Open Patent Publication (Kokai) No. 2011-51570 is performed, the degree of unstableness of the vehicle or the like is reduced compared with a case where the lane-keeping assist control is not performed, whereby the traveling state of the vehicle is stabilized. This reduces the difference between the estimated steering angle and the actual steering angle, reduces the normalized residual, which can lead to erroneous determination that the driver is in a high vigilance state in spite of being in a low vigilance state.

### SUMMARY OF THE INVENTION

It is an object of the present invention to provide a driver state determination system capable of accurately determining a state of vigilance of a driver, for a vehicle in which steering assist control is performed.

To attain the above object, the present invention provides a driver state determination system comprising steering assist control means for performing steering assist control for assisting a driver to steer a vehicle such that the vehicle keeps traveling along a lane, and driver state determination means for determining a state of vigilance of the driver according to a state of steering of the vehicle by the driver, wherein the driver state determination means includes first determination means for determining the state of vigilance of the driver, using a predetermined first determination method, when the steering assist control is being performed, and second determination means for determining the state of vigilance of the driver, using a predetermined second determination method different from the predetermined first determination method, when the steering assist control is stopped.

According to this driver state determination system, when the steering assist control is being performed, the state of vigilance of the driver is determined using the predetermined first determination method, whereas when the steering assist control is stopped, the state of vigilance of the driver is determined using the predetermined second determination method different from the predetermined first determination method. Therefore, it is possible to accurately determine the state of vigilance of the driver by taking into account whether the steering assist control is being performed or stopped, whereby it is possible to enhance marketability.

Preferably, the driver state determination system further comprises steering force parameter acquisition means for acquiring a steering force parameter indicative of a steering force of the driver, and steering amount parameter acquisition means for acquiring a steering amount parameter indicative of a steering amount of the driver, and in the predetermined first determination method, the state of vigilance of the driver is determined using the acquired steering force parameter, whereas in the predetermined second determination method, the state of vigilance of the driver is determined using the acquired steering amount parameter.

With the configuration of the preferred embodiment, in the predetermined first determination method, the state of vigilance of the driver is determined using the acquired steering force parameter, and in the predetermined second determination method, the state of vigilance of the driver is determined using the acquired steering amount parameter. In general, the steering amount of the driver decreases during execution of the steering assist control. Therefore, in a case where the state of vigilance of the driver is determined using the steering amount parameter indicative of the steering amount of the driver, there is a fear that the vigilance of the driver is erroneously determined to be high though it is low. However, the steering force of the driver has a high correlation with the state of vigilance of the driver even during execution of the steering assist control, and hence in a case where the steering assist control is being performed, by determining the state of vigilance of the driver using the steering force parameter indicative of the steering force of the driver, it is possible to improve the determination accuracy compared with a case where the steering amount parameter is used. On the other hand, when the steering assist control is stopped, the steering amount of the driver has a high correlation with the state of vigilance of the driver, and hence in the case where the steering assist control is stopped, by determining the state of vigilance of the driver using the steering amount parameter indicative of the steering amount of the driver, it is possible to ensure high determination accuracy. Based on the above-described principles, the state of vigilance of the driver can be accurately determined by taking into account whether the steering assist control is being performed or stopped, thereby making it possible to improve the determination accuracy. This makes it possible to further enhance marketability (note that throughout the description, the term “acquire” used in phrases “acquiring the steering force parameter” and “acquiring the steering amount parameter” is intended to mean not only directly detecting these parameters e.g. by sensors but also estimating or calculating the parameters based on other values).

Preferably, the driver state determination means further includes correction steering amount calculation means for calculating a correction steering amount indicative of a degree of correction of the steering amount by the driver, and in the predetermined first determination method, the state of vigilance of the driver is determined using a result of comparison of the calculated correction steering amount with a predetermined first reference value, whereas in the predetermined second determination method, the state of vigilance of the driver is determined using a result of comparison of the calculated correction steering amount with a predetermined second reference value different from the predetermined first reference value.

With the configuration of the preferred embodiment, the correction steering amount indicative of the degree of correction of the steering amount by the driver is calculated. In the predetermined first determination method, the state of vigilance of the driver is determined using a result of comparison of the calculated correction steering amount with the predetermined first reference value, whereas in the predetermined second determination method, the state of vigilance of the driver is determined using a result of comparison of the calculated correction steering amount with the predetermined second reference value different from the predetermined first reference value. Here, in a case where the steering assist control is switched between execution and non-execution, there is a change in the degree of correction of the steering amount by the driver, and hence the correction steering amount takes values indicating different degrees of correction depending on whether the steering assist control is being performed or not. For example, in general, when the steering assist control is stopped, the degree of correction of the steering amount by the driver becomes larger than when the steering assist control is being performed, so that the correction steering amount takes a value indicating a larger degree of correction. Therefore, by setting the second reference value which is compared with the correction steering amount in the second determination method, to a value different from the first reference value which is compared with the correction steering amount in the first determination method, the state of vigilance of the driver can be accurately determined by taking into account whether the steering assist control is being performed or stopped, whereby it is possible to improve the determination accuracy. This makes it possible to further enhance marketability.

More preferably, the predetermined second reference value is set to a value indicating a tendency of being larger in the correction steering amount, than the predetermined first reference value.

As described above, when the steering assist control is stopped, the degree of correction of the steering amount by the driver is larger than when the steering assist control is being performed. With the configuration of the preferred embodiment, however, the predetermined second reference value is set to a value indicating a tendency of being larger in the correction steering amount, than the predetermined first reference value, and hence when the steering assist control is stopped, by using a result of comparison of the correction steering amount with the predetermined second reference value indicating a tendency of being larger in the correction steering amount, than the predetermined first reference value, it is possible to determine the state of vigilance of the driver, while coping with an increase in the degree of correction of the steering amount due to the stop of the steering assist control. This makes it possible to further improve the determination accuracy.

More preferably, the predetermined first reference value and the predetermined second reference value are each calculated using values of the correction steering amount calculated at respective calculation times up to the current calculation time.

With the configuration of the preferred embodiment, since the predetermined first and second reference values are calculated using values of the correction steering amount calculated at respective calculation times up to the current calculation time, it is possible to determine the state of vigilance of the driver while causing steering characteristics of the driver over a time period up to the current time to be reflected thereon. This makes it possible to avoid erroneous determination due to a personal difference or variation in the steering characteristics of the driver, whereby it is possible to further improve the determination accuracy.

Preferably, the driver state determination system further comprises warning means for providing warning information to the driver based on a result of determination by the driver state determination means when the state of vigilance of the driver is low.

With the configuration of the preferred embodiment, warning information is provided to the driver based on a result of determination by the driver state determination means when the state of vigilance of the driver is low, and hence it is possible to cause the driver to recognize that the vigilance of the driver is low, whereby it is possible to improve safety.

The above and other objects, features, and advantages of the present invention will become more apparent from the following detailed description taken in conjunction with the accompanying drawings.

### BRIEF DESCRIPTION OF THE DRAWINGS

FIG. 1 is a schematic diagram of a driver state determination system according to a first embodiment of the present invention;

FIG. 2 is a flowchart of an EPS control process;

FIG. 3 is a flowchart of a driver state determination process;

FIG. 4 is a flowchart of an on-time determination process;

FIG. 5 is a flowchart of an off-time determination process;

FIG. 6 is a flowchart of a variation of the on-time determination process;

FIG. 7 is a flowchart of another variation of the on-time determination process; and

FIG. 8 is a flowchart of a driver state determination process performed by a driver state determination system according to a second embodiment of the present invention.

### DETAILED DESCRIPTION OF PREFERRED EMBODIMENTS

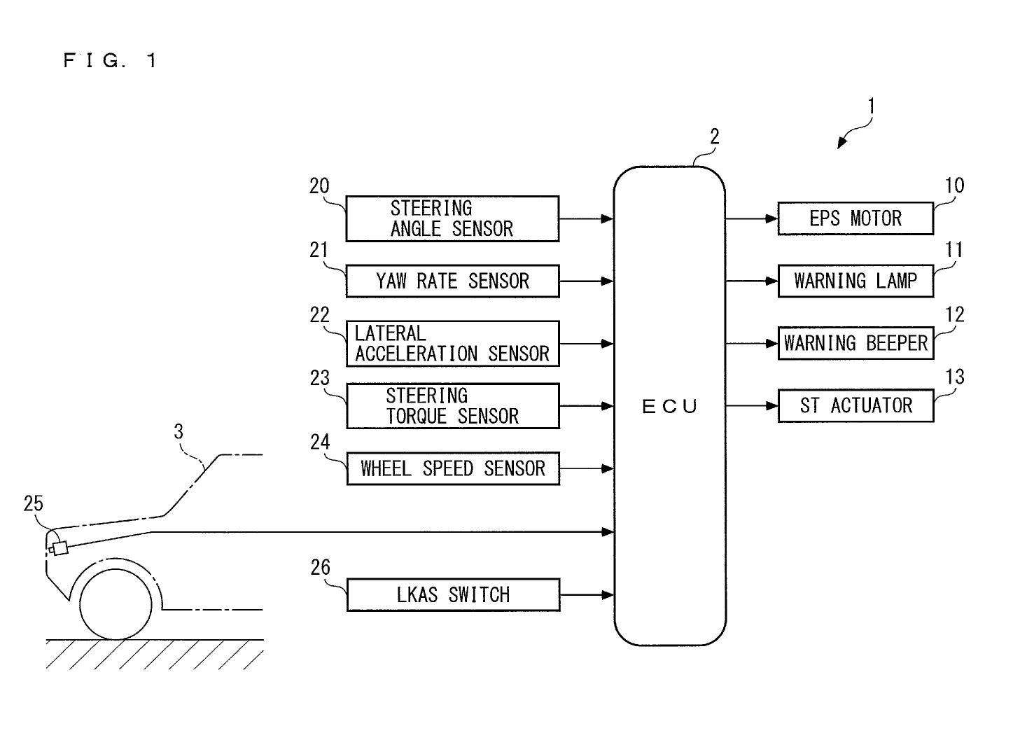

Hereafter, a driver state determination system according to a first embodiment of the present invention will be described with reference to the drawings. As shown in FIG. 1, the driver state determination system 1 according to the present embodiment is applied to a vehicle 3, and includes an ECU 2. As described hereinafter, the ECU 2 performs an EPS (Electric Power Steering) control process, a driver state determination process, and so forth.

The vehicle 3 is a four-wheel type (only one of which is shown), and includes an electric power steering device (not shown) for assisting a steering force of a driver. The electric power steering device includes an EPS motor 10. The EPS motor 10 is electrically connected to the ECU 2. The ECU 2 controls assist torque generated by the EPS motor 10 in the EPS control process described hereinafter.

Further, a warning lamp 11, a warning beeper 12, and an ST (stepping) actuator 13 are electrically connected to the ECU 2. Both the warning lamp 11 and the warning beeper 12 are disposed on a meter panel (not shown) of the vehicle 3, and provide warning information e.g. according to a vigilance level ATT_LVL of the driver in a warning control process, described hereinafter.

Further, the ST actuator 13 is mounted on a steering device (not shown) of the vehicle 3. For example, when the vigilance level ATT_LVL of the driver indicates a lowered vigilance of the driver, to warn the lowered vigilance, a steering wheel (not shown) of the steering device is vibrated by the ST actuator 13.

Furthermore, a steering angle sensor 20, a yaw rate sensor 21, a lateral acceleration sensor 22, a steering torque sensor 23, four wheel speed sensors 24 (only one of which is shown), a front camera 25, and an LKAS (Lane-Keeping Assist System) switch 26 are electrically connected to the ECU 2.

The steering angle sensor 20 detects a steering angle θs of the steering wheel, and delivers a detection signal indicative of the detected steering angle θs to the ECU 2. The yaw rate sensor 21 detects a yaw rate Yr of the vehicle 3, and delivers a detection signal indicative of the detected yaw rate Yr to the ECU 2. Further, the lateral acceleration sensor 22 detects a degree Gy of acceleration of the vehicle 3 in a lateral direction (hereinafter referred to as the “lateral acceleration Gy”), and delivers a detection signal indicative of the detected lateral acceleration Gy to the ECU 2. The steering torque sensor 23 detects torque Ts for operating the steering wheel of the driver (hereinafter referred to as the “steering torque Ts”) and delivers a detection signal indicative of the detected steering torque Ts to the ECU 2. The ECU 2 calculates the steering angle θs, the yaw rate Yr, the lateral acceleration Gy, the steering torque Ts, and so forth, based on these and other detection signals, respectively.

Note that in the present embodiment, the steering angle sensor 20 corresponds to steering amount parameter acquisition means, the steering angle θs corresponds to a steering amount parameter, the steering torque sensor 23 corresponds to steering force parameter acquisition means, and the steering torque Ts corresponds to a steering force parameter.

Further, each of the four wheel speed sensors 24 detects the rotational speed of an associated one of the wheels, and delivers a signal indicative of the detected rotational speed to the ECU 2. The ECU 2 calculates a vehicle speed VP and the like, based on the detection signals from the wheel speed sensors 24. On the other hand, the front camera 25 photographs white lines indicating a lane in front of the vehicle V, and delivers an image signal indicative of the white lines to the ECU 2. The ECU 2 calculates a target azimuth angle θd_cmd based on the image signal from the front camera 25.

On the other hand, the LKAS switch 26 is formed on an instrument panel (not shown). When the driver desires execution of a lane-keeping assist control process (hereinafter referred to as the “LKAS control process”), the LKAS switch 26 is turned on, and otherwise turned off. The LKAS switch 26 delivers an output signal indicative of an ON/OFF state thereof to the ECU 2.

The ECU 2 is implemented by a microcomputer comprised of a CPU, a RAM, a ROM, and an I/O interface (none of which are specifically shown). The ECU 2 performs the EPS control process and the driver state determination process, as described hereinafter, according to the detection signals from the above-described sensors 20 to 24, the image signal from the front camera 25, and the output signal from the LKAS switch 26.

Note that in the present embodiment, the ECU 2 corresponds to steering assist control means, driver state determination means, first determination means, second determination means, steering force parameter acquisition means, steering amount parameter acquisition means, correction steering amount calculation means, and warning means.

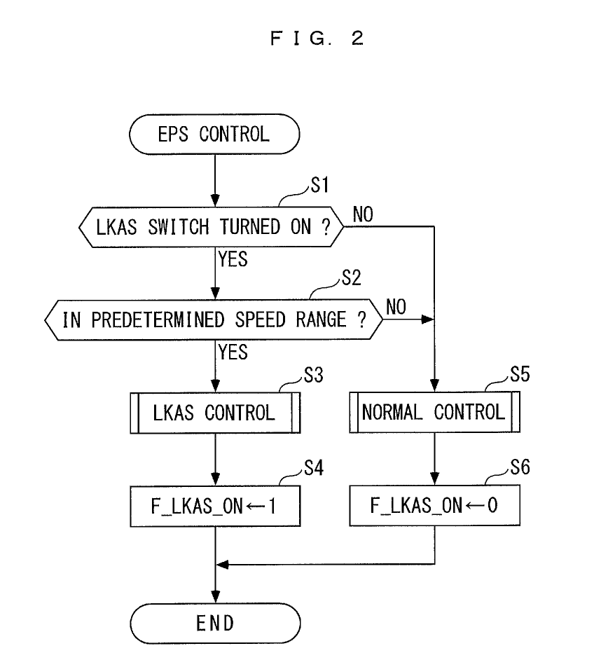

Next, the EPS control process will be described with reference to FIG. 2. The EPS control process controls the EPS motor 10 of the electric power steering device, to thereby control torque generated by the EPS motor 10, i.e. assist torque for assisting the driver to steer the vehicle. The EPS control process is performed by the ECU 2 at a predetermined control period. Note that it is assumed that various calculated values and set values, referred to in the following description, are stored in the RAM of the ECU 2.

Referring to FIG. 2, first, in a step 1 (shown as S1 in abbreviated form in FIG. 2; the following steps are also shown in abbreviated form), it is determined based on the output signal from the LKAS switch 26 whether or not the LKAS switch 26 is in the ON state.

If the answer to this question is affirmative (YES), it is determined that the driver desires execution of the LKAS control process, so that the process proceeds to a step 2, wherein it is determined whether or not the vehicle speed VP is in a predetermined speed range. If the answer to this question is affirmative (YES), it is determined that conditions for executing the LKAS control process are satisfied, so that the process proceeds to a step 3, wherein the LKAS control process is performed.

The LKAS control process controls the EPS motor 10 such that the assist torque for causing the vehicle 3 to travel in the center of a lane is generated. In the case of the step 3, the LKAS control process is performed by the same control method as disclosed in Japanese Laid-Open Patent Publication (Kokai) No. 2011-51570, though details of the LKAS control process are not shown. That is, a lane in front of the vehicle V is recognized based on the image signal from the front camera 25, and a lane-keeping assist torque for causing the vehicle 3 to travel in the center of the lane is calculated based on a result of the recognition. Further, a steering assist torque is calculated e.g. based on the steering angle θs, the lateral acceleration Gy, and the vehicle speed VP. Then, the EPS motor 10 is controlled such that it generates the sum of the lane-keeping assist torque and the steering assist torque.

In a step 4 following the step 3, to indicate that the LKAS control process is being performed, an LKAS control in-process flag F_LKAS_ON is set to 1, followed by terminating the present process.

On the other hand, if the answer to the question of the above-described step 1 or 2 is negative (NO), i.e. if the LKAS switch 26 is in the OFF state, or if the vehicle speed VP is not in the predetermined speed range, it is determined that the conditions for executing the LKAS control process are not satisfied and hence a normal control process should be performed, so that the process proceeds to a step 5, wherein the normal control process is performed. In the normal control process, a steering assist torque is calculated e.g. based on the steering angle θs, the lateral acceleration Gy, and the vehicle speed VP, and the EPS motor 10 is controlled such that it generates the steering assist torque.

In a step 6 following the step 5, to indicate that the LKAS control process is not being performed (i.e. the LKAS control process is stopped), the LKAS control in-process flag F_LKAS_ON is set to 0, followed by terminating the present process.

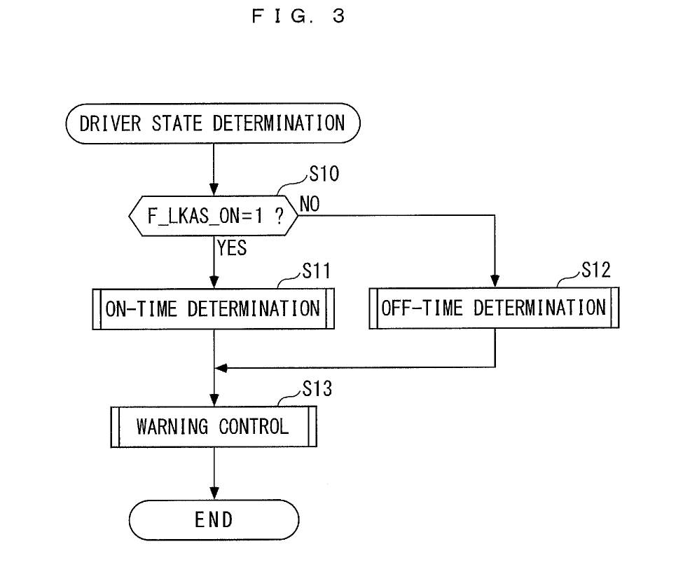

Next, the driver state determination process will be described with reference to FIG. 3. The driver state determination process determines a high or low vigilance state of the driver, based on the steering torque Ts and the steering angle θs, and is performed by the ECU 2 at a predetermined period.

Referring to FIG. 3, first, in a step 10, it is determined whether or not the above-mentioned LKAS control in-process flag F_LKAS_ON is equal to 1. If the answer to this question is affirmative (YES), i.e. if the LKAS control process is being performed, the process proceeds to a step 11, wherein an on-time determination process is performed.

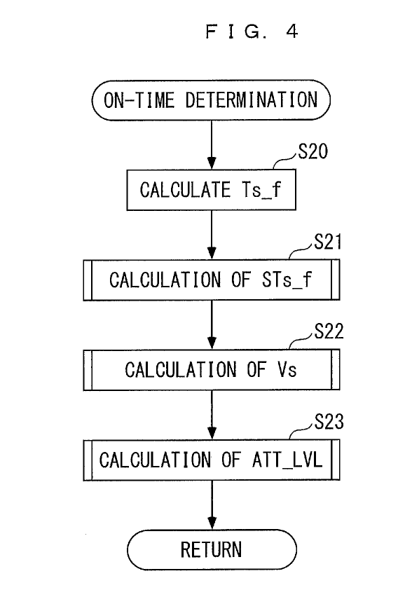

As described hereinafter, the on-time determination process determines the high or low vigilance state of the driver, using the steering torque Ts, and is specifically performed as shown in FIG. 4.

Referring to FIG. 4, first, in a step 20, a steering torque filter value Ts_f is calculated. The steering torque filter value Ts_f is calculated by performing a predetermined bandpass filtering operation on the steering torque Ts calculated based on the detection signal from the steering torque sensor 23.

A passband of a bandpass filter for filtering the detection signal from the steering torque sensor 23 is set to a frequency range corresponding to a range of natural frequencies of the steering torque Ts in order to accurately extract only the component of the steering torque Ts from the detection signal. With this setting, the steering torque filter value Ts f is calculated as a value accurately indicative of only the steering torque Ts, which is obtained by eliminating noises from the detection signal from the steering torque sensor 23.

Then, the process proceeds to a step 21, wherein a process for calculating an integral value of the steering torque filter value (hereinafter simply referred to as the “integral value”) STs_f is performed. In this calculation process, the current integral value is calculated by adding the steering torque filter value Ts_f calculated in the above-described step 20 to an integral value of the steering torque filter value Ts_f, calculated thus far. When the number of times of integration performed thus far has reached a predetermined value, an integral value at the time is stored as one integral value STs_f in the RAM, and then it is reset to 0. Therefore, as the control proceeds, the above-described integration, storage, and resetting are repeatedly performed, whereby the number of the integral values STs_f stored in the RAM is increased.

Next, in a step 22, a variance Vs of the integral values STs_f is calculated by the following equation (1) :

$$Vs = \frac{1}{n} {\sum }_{i = 1}^{n} {( STs\_fave - {STs\_f}_{i} )}^{2} \qquad ( 1 )$$

In the above equation (1), STs_fave represents an arithmetic mean value of n (n is an integer not smaller than 2) integral values STs_f calculated at respective control times up to the current control time. Note that the calculation of the variance Vs in the step 22 is performed whenever the number of the integral values STs_f calculated in the above-described step 21 reaches n.

In a step 23 following the step 22, the vigilance level ATT_LVL is calculated by the following equations (2) to (6). Note that in the following equations (2) to (6), Vs1 to Vs4 represent predetermined threshold values (positive values) set such that Vs1<Vs2<Vs3<Vs4 holds.

When Vs<Vs1 holds, ATT_LVL=5 (2)

When Vs1≦Vs<Vs2 holds, ATT_LVL=4 (3)

When Vs2≦Vs<Vs3 holds, ATT_LVL=3 (4)

When Vs3≦Vs<Vs4 holds, ATT_LVL=2 (5)

When Vs4≦Vs holds, ATT_LVL=1 (6)

As is apparent from the equations (2) to (6), in the step 23, the vigilance level ATT_LVL is calculated as one of the values 1 to 5 based on results of comparison of the variance Vs with the threshold values Vs1 to Vs4, and is calculated as a smaller value as the variance Vs is larger. In this case, the fact that the variance Vs is large indicates that a fluctuation in the steering torque Ts is large, so that it is estimated that as the variance Vs is larger, the vigilance of the driver is lower. That is, the vigilance level ATT_LVL is calculated as a smaller value as the vigilance of the driver is lower. In other words, the vigilance level ATT_LVL is calculated as a larger value as the vigilance of the driver is higher.

After the vigilance level ATT_LVL is thus calculated in the step 23, the present process is terminated.

Referring again to FIG. 3, after the on-time determination process is performed in the step 11 as described above, the process proceeds to a step 13, described hereinafter.

On the other hand, if the answer to the question of the above-described step 10 is negative (NO), i.e. if the LKAS control process is not being performed, the process proceeds to a step 12, wherein an off-time determination process is performed.

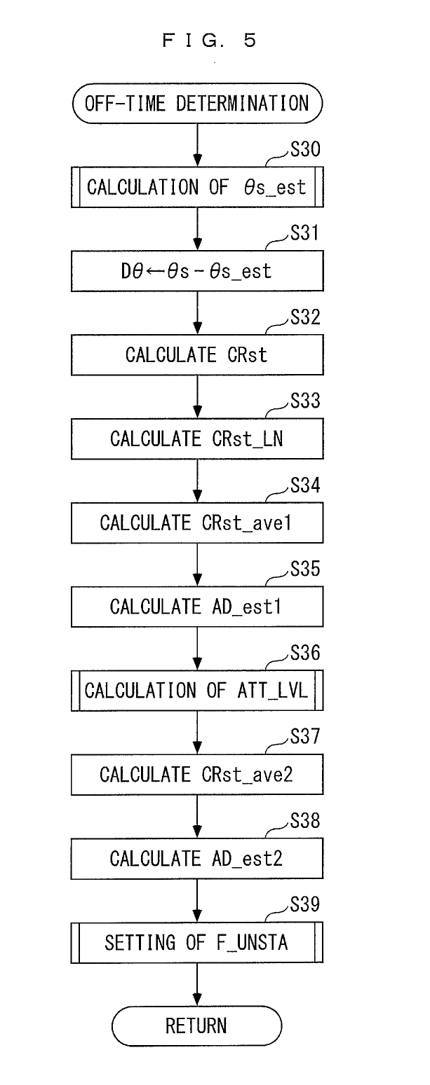

As described hereinafter, the off-time determination process determines the high or low vigilance state of the driver, using the steering angle θs, and is specifically executed as shown in FIG. 5.

Referring to FIG. 5, first, in a step 30, an estimated steering angle θs_est is calculated. Although not shown, in this calculation process, the estimated steering angle θs_est is calculated by the same calculation method as disclosed in International Publication Pamphlet No. WO2011/040390.

More specifically, an actual azimuth angle θd is calculated based on an integral value of the yaw rate Yr. Then, the target azimuth angle θd_cmd is calculated based on the aforementioned image signal from the front camera 25, and an azimuth angle difference Dθd is calculated as a difference between the actual azimuth angle θd and the target azimuth angle θd cmd (θd−θd_cmd). Then, a discrete-time system model to which is input the azimuth angle difference Dθd and from which is output the estimated steering angle θs_est is defined, and model parameters of the discrete-time system model are calculated with a predetermined onboard identification algorithm (e.g. a least-square method algorithm). Then, the estimated steering angle θs_est is calculated by substituting the calculated model parameters and the calculated azimuth angle difference Dθd into the discrete-time system model.

Then, the process proceeds to a step 31, wherein a steering angle difference Dθ is set to a difference between the steering angle θs and the estimated steering angle θs_est (θs−θs_est).

Next, in a step 32, a correction steering amount CRst is calculated by the following equation (7):

$$CRst = \sqrt{\frac{1}{m} {\sum }_{j = 1}^{m} {( D {θ}_{j} )}^{2}} \qquad ( 7 )$$

In the above equation (7), m represents a positive integer not smaller than 2. As expressed by the equation (7), the correction steering amount CRst is calculated as a mean squared error (i.e. a root mean square) of m steering angle differences Dθ calculated at respective control times up to the current control time.

In a step 33 following the step 32, a learned value CRst_LN of the correction steering amount (hereinafter referred to as the “learned correction steering amount CRst_LN”) is calculated. The learned correction steering amount CRst_LN is calculated as a minimum value of values of the correction steering amount CRst calculated at respective control times up to the current control time when the LKAS control process is not being performed. That is, in the step 33, the correction steering amount CRst calculated in the above-described step 32 and a learned correction steering amount CRst_LN stored in the RAM are compared with each other, and a smaller one of the two amounts is set as the learned correction steering amount CRst_LN.

Then, the process proceeds to a step 34, wherein a first average correction steering amount CRst_ave1 is calculated. The first average correction steering amount CRst_ave1 is calculated as a moving average value of values of the correction steering amount CRst calculated at respective control times up to the current control time over a predetermined sampling time period.

Next, in a step 35, a first estimated alertness degree AD_est1 is calculated by the following equation (8):

$$AD\_est 1 = \frac{CRst\_ave 1}{CRst\_LN} \qquad ( 8 )$$

In a step 36 following the step 35, the vigilance level ATT_LVL is calculated by the following equations (9) to (13). Note that in the following equations (9) to (13), AD1 to AD4 represent predetermined threshold values (positive values) set such that AD1<AD2<AD3<AD4 holds.

When AD_est1<AD1 holds, ATT_LVL=5 (9)

When AD1≦AD_est1<AD2 holds, ATT_LVL=4 (10)

When AD2≦AD_est1<AD3 holds, ATT_LVL=3 (11)

When AD3≦AD_est1<AD4 holds, ATT_LVL=2 (12)

When AD4≦AD_est1 holds, ATT_LVL=1 (13)

As is apparent from the above-mentioned equations (9) to (13), in the step 36, the vigilance level ATT_LVL is calculated as one of the values 1 to 5 based on a result of comparison of the first estimated alertness degree AD_est1 with the threshold values AD1 to AD4, and is calculated as a smaller value as the first estimated alertness degree AD_est1 is larger. In this case, the fact that the first estimated alertness degree AD_est1 is large indicates that a fluctuation in the steering angle θs is large, so that it is estimated that as the first estimated alertness degree AD_est1 is larger, the vigilance of the driver is lower. That is, the vigilance level ATT_LVL is calculated as a smaller value as the vigilance of the driver is lower.

Then, the process proceeds to a step 37, wherein a second average correction steering amount CRst_ave2 is calculated. The second average correction steering amount CRst_ave2 is calculated as a moving average value of values of the correction steering amounts CRst calculated at respective control times up to the current control time over a predetermined sampling time period shorter than the predetermined sampling time period of the first average correction steering amount CRst_ave1.

Next, in a step 38, a second estimated alertness degree AD_est2 is calculated by the following equation (14):

$$AD\_est 2 = \frac{CRst\_ave 2}{CRst\_LN} \qquad ( 14 )$$

In a step 39 following the step 38, an unstableness flag F_UNSTA is calculated by the following equations (15) and (16). Note that in the following equations (15) and (16), AD_JUD represents a predetermined determination value for determining whether or not an unstable traveling state of the vehicle 3 is occurring.

When AD_est2<AD_JUD holds, F_UNSTA=0 (15)

When AD_JUD≦AD_est2 holds, F_UNSTA=1 (16)

As expressed by the above equations (15) and (16), when the second estimated alertness degree AD_est2 is not smaller than the predetermined determination value AD_JUD, to indicate that the unstable traveling state of the vehicle 3 is occurring, the unstableness flag F_UNSTA is set to 1, and otherwise, to indicate that the vehicle 3 is in a stable traveling state, the unstableness flag F_UNSTA is set to 0.

After the unstableness flag F_UNSTA is thus set in the step 39, the present process is terminated.

Referring again to FIG. 3, after the off-time determination process is thus performed in the step 12, the process proceeds to the step 13, described hereinafter.

In the step 13 following the above step 11 or 12, the warning control process is performed. In the warning control process, when it is during execution of the LKAS control process and when the on-time determination process is being performed, warning information is provided to the driver by driving the warning lamp 11, the warning beeper 12, and the ST actuator 13, based on a value of the above-described vigilance level ATT_LVL. Particularly when the value of the above-described vigilance level ATT_LVL is small (e.g. not larger than 2), the driver is warned that the vigilance of the driver is lowered, by flashing the warning lamp 11, reducing an interval between generation of sound from the warning beeper 12, and vibrating the steering wheel by the ST actuator 13.

On the other hand, when it is during the stoppage of the LKAS control process and when the off-time determination process is being performed, warning information is provided to the driver by driving the warning lamp 11, the warning beeper 12, and the ST actuator 13, based on values of the above-described vigilance level ATT_LVL and unstableness flag_FUNSTA.

After the warning control process is thus performed in the step 13, the present process is terminated.

As described hereinabove, according to the driver state determination system 1 of the present embodiment, in the driver state determination process in FIG. 3, the on-time determination process is performed when the LKAS control process is being performed, whereas when the LKAS control process is not being performed, the off-time determination process is performed. In the on-time determination process, the state of vigilance of the driver is determined using the steering torque Ts, and the vigilance level ATT_LVL is set based on a result of the determination. On the other hand, in the off-time determination process, the state of vigilance of the driver is determined using the steering angle θs, and the vigilance level ATT_LVL and the unstableness flag F_UNSTA are set based on a result of the determination. Further, when the LKAS control process is being performed, warning information is provided to the driver based on the vigilance level ATT_LVL, whereas when the LKAS control process is not being performed, warning information is provided to the driver based on the vigilance level ATT_LVL and the unstableness flag F_UNSTA.

In general, the steering amount of the driver decreases during execution of the LKAS control process, and hence when the state of vigilance of the driver is determined using the steering angle θs, there is a fear that the vigilance of the driver is erroneously determined to be high in spite of the fact that the vigilance of the driver is low. On the other hand, the steering torque Is has a high correlation with the state of vigilance of the driver even during execution of the LKAS control process, and hence, in a case where the LKAS control process is being performed, by determining the state of vigilance of the driver using the steering torque Ts, it is possible to improve the determination accuracy compared with the case where the steering angle θs is used.

On the other hand, when the LKAS control process is not being performed, the steering angle θs has a high correlation with the state of vigilance of the driver, and hence by determining the state of vigilance of the driver using the steering angle θs under such a condition, it is possible to ensure high determination accuracy. Based on the above-described principles, the state of vigilance of the driver can be accurately determined by taking into account whether the LKAS control process is being performed or stopped. This makes it possible to improve the determination accuracy, whereby it is possible to enhance marketability.

Further, when the LKAS control process is being performed, warning information is provided to the driver based on the vigilance level ATT_LVL, whereas when the LKAS control process is not being performed, warning information is provided to the driver based on the vigilance level ATT_LVL and the unstableness flag F_UNSTA. Therefore, it is possible to cause the driver to properly recognize that the vigilance of the driver is low, whereby it is possible to improve safety.

Note that although in the first embodiment, the lane-keeping assist control process is performed as an example of the steering assist control process, the steering assist control process of the present invention is not limited to this, but any suitable steering assist control process may be performed insofar as it assists the driver to steer the vehicle such that the vehicle keeps traveling along the travel lane.

Further, although in the first embodiment, the steering torque Ts is used as an example of the steering force parameter, the steering force parameter of the present invention is not limited to this, but any suitable steering force parameter may be used insofar as it represents the steering force of the driver. For example, as the steering force parameter, there may be used a steering force (value obtained by dividing the steering torque Ts by a diameter of the steering wheel), or an integral value or a differential value of the steering torque Ts.

Further, although in the first embodiment, the steering angle θs is used as an example of the steering amount parameter, the steering amount parameter of the present invention is not limited to this, but any suitable steering amount parameter may be used insofar as it represents the steering amount of the driver. For example, as the steering amount parameter, there may be used a steering angular speed or an integral value thereof.

Further, although in the first embodiment, the equations (2) to (6) and (9) to (13) are used as an example of the method of calculating the vigilance level ATT_LVL in the steps 23 and 36, the vigilance level ATT_LVL may be calculated by searching maps in stead of using these equations. Furthermore, although in the step 39, the equations (15) and (16) are used as the method of calculating the unstableness flag F_UNSTA, the unstableness flag F_UNSTA may be calculated by searching maps in stead of using these equations.

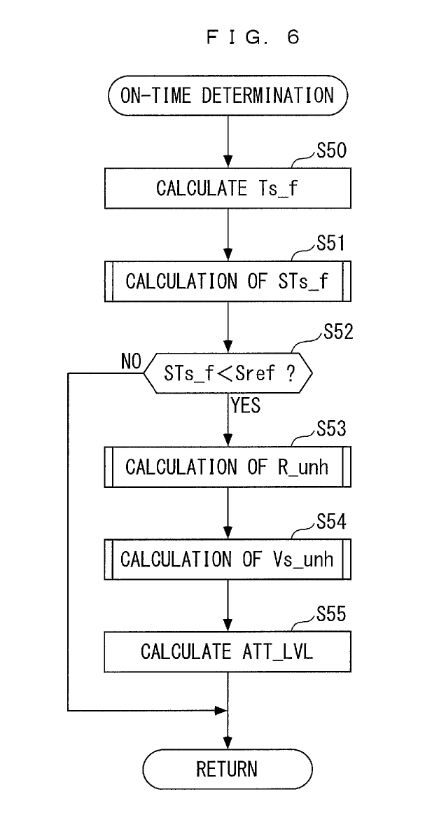

Furthermore, although in the first embodiment, the determination process shown in FIG. 4 is performed as an example of the on-time determination process, the determination process shown in FIG. 4 may be replaced by an on-time determination process shown in FIG. 6.

Referring to FIG. 6, in this on-time determination process, first, in steps 50 and 51, the steering torque filter value Ts_f and the integral value STs_f thereof are calculated by the same calculation methods as employed in the above-described steps 20 and 21 in FIG. 4.

Then, the process proceeds to a step 52, wherein it is determined whether or not the integral value STs_f is smaller than a predetermined value Sref. This determination is performed in the step 51 whenever the integral value STs_f is calculated.

If the answer to the question of the step 52 is negative (NO), i.e. if STs_f≧Sref holds, it is determined that the driver is properly gripping the steering wheel, and the present process is immediately terminated.

On the other hand, if the answer to the question of the step 52 is affirmative (YES), it is determined that the driver has released the steering wheel, and the process proceeds to a step 53, wherein a process for calculating a release occurrence frequency R_unh is performed.

In this calculation process, the number of times occurrence of an affirmative answer (YES) to the question of the step 52, i.e. the number of times of releasing the steering wheel is counted and stored in the RAM. Further, whenever the number of the integral values STs_f calculated in the step 51 reaches a predetermined value k (k is an integer not smaller than 2), the release occurrence frequency R_unh is calculated using the stored number of times of releasing the steering wheel. The release occurrence frequency R_unh indicates a ratio (e.g. %) of the number of times of occurrence of releasing the steering wheel to the number of k times of calculating the integral values STs_f. This means that as the value of the release occurrence frequency R_unh is larger, the driver is repeating the release of the steering wheel more frequently.

Then, the process proceeds to a step 54, wherein a process for calculating a variance Vs_unh of a time interval' at which the release of the steering wheel occurs. In this calculation process, the time interval is calculated and a calculated value thereof is stored in the RAM. Further, whenever the number of the integral values STs_f calculated in the step 51 reaches the predetermined value k, the variance Vs_unh of the time interval is calculated using calculated values of the time interval stored in the RAM. The variance Vs_unh of the time interval is calculated by a method similar to the method employed for calculating the variance Vs in the above-described step 22 in FIG. 4. As the variance Vs_unh is larger, variation in the time interval at which the release of the steering wheel occurs is larger. This means that the vigilance of the driver has lowered.

In a step 55 following the step 54, the vigilance level ATT_LVL is calculated by searching a map (not shown) according to the release occurrence frequency R_unh and the variance Vs_unh of the time interval at which the release of the steering wheel occurs. In this map, the vigilance level ATT_LVL is set to one of the values 1 to 5. Further, the calculation of the vigilance level ATT_LVL in the step 55 is performed whenever the release occurrence frequency R_unh and the variance Vs_unh are calculated in the steps 53 and 54.

After the vigilance level ATT_LVL is calculated in the step 55 as described above, the present process is terminated.

When the above-described on-time determination process shown in FIG. 6 is performed as well, it is possible to obtain the same advantageous effects as obtained by performing the on-time determination process shown in FIG. 4. That is, during execution of the LKAS control process, the state of vigilance of the driver is determined using the steering torque Ts, and hence it is possible to improve the accuracy of the determination compared with the case where the steering angle θs is used.

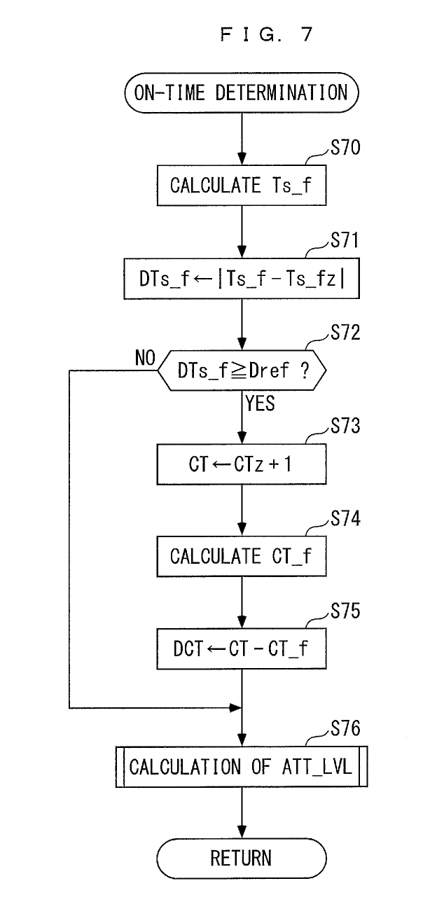

Further, an on-time determination process shown in FIG. 7 may be performed in place of the on-time determination process shown in FIG. 4. Referring to FIG. 7, in this on-time determination process, first, in a step 70, the steering torque filter value Ts_f is calculated by the same calculation method as employed in the above-described step 20 in FIG. 4.

Then, the process proceeds to a step 71, wherein a steering torque difference DTs_f is set to an absolute value |Ts_f−Ts_fz| of a difference between the current value Ts_f of the steering torque filter value and an immediately preceding value Ts_fz thereof. In this case, the current value Ts_f of the steering torque filter value and the immediately preceding value Ts_fz thereof correspond to steering torque filter values calculated at the current and immediately preceding control times, respectively.

Next, in a step 72, it is determined whether or not the steering torque difference DTs_f is not smaller than a predetermined value Dref. If the answer to this question is negative (NO), i.e. if a fluctuation in the steering torque filter value Ts_f is small, the process proceeds to a step 76, referred to hereinafter.

On the other hand, if the answer to the question of the step 72 is affirmative (YES), i.e. if the fluctuation in the steering torque filter value Ts_f is large, the process proceeds to a step 73, wherein a count value CT of a change counter is set to the sum CTz+1 of an immediately preceding value CTz thereof and 1. That is, the count value CT of the change counter is incremented by 1.

Then, the process proceeds to a step 74, wherein a counter filter value CT_f is calculated. The counter filter value CT_f is calculated by performing a low-pass filter calculation (i.e. a first-order lag calculation) on the count value CT of the change counter.

In a step 75 following the step 74, a counter difference DCT is set to a difference CT-CT_f between the count value CT of the change counter and the counter filter value CT_f.

Then, the process proceeds to the step 76, wherein the vigilance level ATT_LVL is calculated based on the counter difference DCT. More specifically, the vigilance level ATT_LVL is set by a method similar to the method employed in the above-described step 23 in FIG. 4, i.e. a method of comparing the counter difference DCT with four threshold values DCT1 to DCT4 (DCT1<DCT2<DCT3<DCT4). After the vigilance level ATT_LVL is thus calculated in the step 76, the present process is terminated.

When the above-described on-time determination process shown in FIG. 7 is performed as well, it is possible to obtain the same advantageous effects as obtained by performing the on-time determination process shown in FIG. 4. That is, during execution of the LKAS control process, the state of vigilance of the driver is determined using the steering torque Ts, and hence it is possible to improve the determination accuracy compared with the case where the steering angle θs is used.

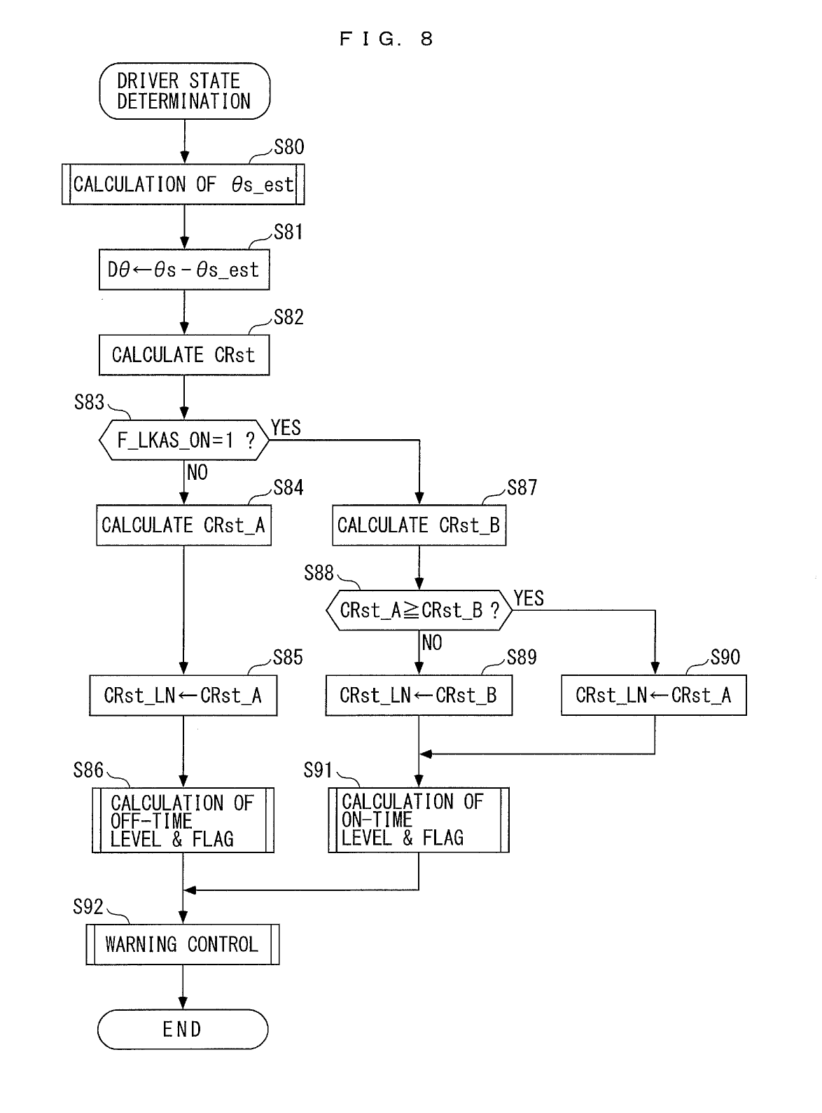

Next, a driver state determination system according to a second embodiment will be described. The driver state determination system is distinguished from the driver state determination system 1 of the first embodiment only in that a driver state determination process shown in FIG. 8 is performed instead of the driver state determination process in FIG. 3. Therefore, the following description is given only of this driver state determination process in FIG. 8.

The driver state determination process shown in FIG. 8 determines a high or low vigilance state of the driver, using the steering angle θs, and is performed by the ECU 2 at a predetermined period. As shown in FIG. 8, first, in steps 80 to 82, the estimated steering angle θs_est, the steering angle difference Dθ, and the correction steering amount CRst are calculated by the same method as employed in the above-described steps 30 to 32 in FIG. 5.

Next, in a step 83, it is determined whether or not the above-mentioned LKAS control in-process flag F_LKAS_ON is equal to 1. If the answer to this question is negative (NO), i.e. if the LKAS control process is not being performed, the process proceeds to a step 84, wherein an off-time learned correction steering amount CRst_A (predetermined second reference value) is calculated.

The off-time learned correction steering amount CRst_A is calculated as a minimum value of values of the correction steering amount CRst calculated at respective control times up to the current control time when the LKAS control process is not being performed. That is, in the step 84, the correction steering amount CRst calculated in the above-described step 82 and an off-time learned correction steering amount CRst_A stored in the RAM are compared with each other, and a smaller one of the two amounts is set as the off-time learned correction steering amount CRst_A.

Then, the process proceeds to a step 85, wherein the learned correction steering amount CRst_LN is set to the off-time learned correction steering amount CRst_A. Then, the process proceeds to a step 86, wherein an off-time level & flag calculation process is performed. In this calculation process, the vigilance level ATT_LVL and the unstableness flag F_UNSTA are calculated by the same methods as employed in the above-described steps 34 to 39 in FIG. 5.

That is, the first estimated alertness degree AD_est1 is calculated by the aforementioned equation (8), and the vigilance level ATT_LVL is calculated by the aforementioned equations (9) to (13). In calculating the first estimated alertness degree AD_est1, the first average correction steering amount CRst_ave1 as a numerator of the equation (8) is calculated using the correction steering amount CRst calculated when the LKAS control process is not being performed.

Further, the second estimated alertness degree AD_est2 is calculated by the aforementioned equation (14), and the unstableness flag F_UNSTA is calculated by the aforementioned equations (15) and (16). Also in calculating the second estimated alertness degree AD_est2, the second average correction steering amount CRst_ave2 as a numerator of the equation (14) is calculated using the correction steering amount CRst calculated when the LKAS control process is not being performed.

After the off-time level & flag calculation process is thus performed in the step 86, the process proceeds to a step 92, referred to hereinafter.

On the other hand, if the answer to the question of the above-described step 83 is affirmative (YES), i.e. if the LKAS control process is being performed, the process proceeds to a step 87, wherein an on-time learned correction steering amount CRst_B (predetermined first reference value) is calculated.

The on-time learned correction steering amount CRst_B is calculated as a minimum value of values of the correction steering amount CRst calculated at respective control times up to the current control time when the LKAS control process is being performed. That is, in the step 86, the correction steering amount CRst calculated in the above-described step 82 and the on-time learned correction steering amount CRst_B stored in the RAM are compared with each other, and a smaller one of the two amounts is set to the on-time learned correction steering amount CRst_B.

Then, the process proceeds to a step 88, wherein it is determined whether or not the off-time learned correction steering amount CRst_A stored in the RAM is not smaller than the on-time learned correction steering amount CRst_B calculated in the step 87. If the answer to this question is negative (NO), i.e. if CRst_B>CRst_A holds, the process proceeds to a step 89, wherein the learned correction steering amount CRst_LN is set to the on-time learned correction steering amount CRst_B.

On the other hand, if the answer to the question of the step 88 is affirmative (YES), the process proceeds to a step 90, wherein the learned correction steering amount CRst_LN is set to the off-time learned correction steering amount CRst_A.

In a step 91 following the above step 89 or 90, an on-time level & flag calculation process is performed. In this calculation process, the vigilance level ATT_LVL and the unstableness flag F_UNSTA are calculated by the same method as employed in the above-described steps 34 to 39 in FIG. 5.

More specifically, the first estimated alertness degree AD_est1 is calculated by the aforementioned equation (8), and the vigilance level ATT_LVL is calculated by the aforementioned equations (9) to (13). In calculating the first estimated alertness degree AD_est1, the first average correction steering amount CRst_ave1 as the numerator of the equation (8) is calculated using the correction steering amount CRst calculated during execution of the LKAS control process.

Further, the second estimated alertness degree AD_est2 is calculated by the aforementioned equation (14), and the unstableness flag F_UNSTA is calculated by the aforementioned equations (15) and (16). Also in calculating the second estimated alertness degree AD_est2, the second average correction steering amount CRst_ave2 as the numerator of the equation (14) is calculated using the correction steering amount CRst calculated during execution of the LKAS control process.

Note that in the present embodiment, the first estimated alertness degree AD_est1 corresponds to a result of comparison of the correction steering amount with the predetermined first reference value and the predetermined second reference value, and the second estimated alertness degree AD_est2 corresponds to a result of comparison of the correction steering amount with the predetermined first reference value and the predetermined second reference value.

In the step 92 following the above step 86 or 91, the warning control process is performed by a method similar to the method employed in the above-described step 13 in FIG. 3. More specifically, warning information is provided to the driver by driving the warning lamp 11, the warning beeper 12, and the ST actuator 13, based on the values of the vigilance level ATT_LVL and the unstableness flag F_UNSTA.

After the warning control process is thus performed in the step 92, the process proceeds is terminated.

In a vehicle, such as the vehicle 3 in the present embodiment, for which the LKAS control process is performed, switching between the execution and non-execution of the LKAS control process causes a change in the degree of correction of the steering amount by the driver, and hence the correction steering amount CRst takes values indicating different degrees of correction depending on the execution and non-execution of the LKAS control process. For example, in general, when the LKAS control process is stopped, the degree of correction of the steering amount by the driver becomes larger than when the LKAS control process is being performed, so that the correction steering amount CRst takes a value indicating a larger degree of correction.

However, in the case of the driver state determination system according to the second embodiment, when the LKAS control process is not being performed, the learned correction steering amount CRst_LN is set to the off-time learned correction steering amount CRst_A. Further, the first and second estimated alertness degrees AD_est1 and AD_est2 are each calculated by dividing a moving average value of values of the correction steering amount CRst calculated during non-execution of the LKAS control process by the learned correction steering amount CRst_LN, and whether the vigilance of the driver is high or low and whether the vehicle is in the unstable traveling state 3 or not are determined based on the calculated AD_est1 and AD_est2 values.

In this case, the off-time learned correction steering amount CRst_A is the minimum value of values of the correction steering amount CRst calculated when the LKAS control process is not being performed, and hence corresponds to a value of the correction steering amount CRst calculated when the vigilance of the driver is estimated to be high. For this reason, by using a ratio (AD_est1, AD_est2) between the moving average value of values of the correction steering amount CRst calculated during non-execution of the LKAS control process, and the off-time learned correction steering amount CRst_A, it is possible to accurately determine the high or low vigilance state of the driver, under the condition that the LKAS control process is not being performed.

On the other hand, during execution of the LKAS control process, the off-time learned correction steering amount CRst_A is used as the learned correction steering amount CRst_LN when CRst_A≧CRst_B holds, whereas when CRst_A<CRst_B holds, the on-time learned correction steering amount CRst_B is used as the learned correction steering amount CRst_LN. Further, the first and second estimated alertness degrees AD_est1 and AD_est2 are each calculated by dividing a moving average value of values of the correction steering amount CRst calculated during execution of the LKAS control process by the learned correction steering amount CRst_LN, and whether the vigilance of the driver is high or low and whether the vehicle 3 is in the unstable traveling state or not are determined based on the calculated AD_est1 and AD_est2 values.

In this case, the off-time learned correction steering amount CRst_A corresponds to the value of the correction steering amount CRst calculated when the LKAS control process is stopped and when the vigilance of the driver is estimated to be high, as described above, and the on-time learned correction steering amount CRst_B corresponds to a value of the correction steering amount CRst calculated when the LKAS control process is being performed and when the vigilance of the driver is estimated to be high. Therefore, by calculating the first and second estimated alertness degrees AD_est1 and AD_est2, using a larger one of the two learned correction steering amounts CRst_A and CRst_B as the learned correction steering amounts CRst_LN, it is possible to accurately determine the high or low state of the vigilance state of the driver during execution of the LKAS control process and occurrence or non-occurrence of the unstable traveling state of the vehicle 3, by using the correction steering amount CRst under a condition that an actual vigilance of the driver is estimated to be more reflected, out of the two conditions that the vigilance of the driver is estimated to be high. In short, it is possible to accurately determine the high or low vigilance state of the driver, even under the condition that the LKAS control process is being performed.

Further, the off-time learned correction steering amount CRst_A is a minimum one of values of the correction steering amount CRst calculated up to the current time during non-execution of the LKAS control process, and the on-time learned correction steering amount CRst_B is a minimum one of values of the correction steering amount CRst calculated up to the current time during execution of the LKAS control process. Therefore, it is possible to determine the high or low vigilance state of the driver and properly set the vigilance level ATT_LVL and the unstableness flag F_UNSTA, while causing the steering characteristics of the driver over a time period up to the current time to be reflected thereon. This makes it possible to avoid erroneous determination due to a personal difference or variation in the steering characteristics of the driver, whereby it is possible to further improve the determination accuracy.

Note that in the second embodiment, the first and second estimated alertness degrees AD_est1 and AD_est2 are used as the results of comparison of the correction steering amount with the predetermined first reference value and the predetermined second reference value, by way of example, the results of comparison of the present invention are not limited to these, but any suitable comparison results may be used insofar as they represent results of comparison of the correction steering amount with the predetermined first reference value and the predetermined second reference value.

For example, a reciprocal of the first estimated alertness degree AD_est1, a difference between one and the other of the first average correction steering amount CRst_ave1 and the learned correction steering amount CRst_LN, or an absolute value of the difference may be used. Further, a reciprocal of the second estimated alertness degree AD_est2, a difference between one and the other of the second average correction steering amount CRst_ave2 and the learned correction steering amount CRst_LN, or an absolute value of the difference may be used.

It is further understood by those skilled in the art that the foregoing are preferred embodiments of the invention, and that various changes and modifications may be made without departing from the spirit and scope thereof.

What is claimed is:

1. A driver state determination system comprising:
steering assist control means for performing steering assist control for assisting a driver to steer a vehicle such that the vehicle keeps traveling along a lane; and
driver state determination means for determining a state of vigilance of the driver according to a state of steering of the vehicle by the driver,
wherein said driver state determination means includes:
first determination means for determining the state of vigilance of the driver using a predetermined first determination method, when the steering assist control is being performed; and
second determination means for determining the state of vigilance of the driver, using a predetermined second determination method different from the predetermined first determination method, when the steering assist control is stopped.

2. The driver state determination system according to claim 1, further comprising steering force parameter acquisition means for acquiring a steering force parameter indicative of a steering force of the driver; and
steering amount parameter acquisition means for acquiring a steering amount parameter indicative of a steering amount of the driver, and
wherein in the predetermined first determination method, the state of vigilance of the driver is determined using the acquired steering force parameter, and
wherein in the predetermined second determination method, the state of vigilance of the driver is determined using the acquired steering amount parameter.

3. The driver state determination system according to claim 1, wherein said driver state determination means further includes correction steering amount calculation means for calculating a correction steering amount indicative of a degree of correction of the steering amount by the driver,
wherein in the predetermined first determination method, the state of vigilance of the driver is determined using a result of comparison of the calculated correction steering amount with a predetermined first reference value, and
wherein in the predetermined second determination method, the state of vigilance of the driver is determined using a result of comparison of the calculated correction steering amount with a predetermined second reference value different from the predetermined first reference value.

4. The driver state determination system according to claim 3, wherein the predetermined second reference value is set to a value indicating a tendency of being larger in the correction steering amount, than the predetermined first reference value.

5. The driver state determination system according to claim 3, wherein the predetermined first reference value and the predetermined second reference value are each calculated using values of the correction steering amount calculated at respective calculation times up to the current calculation time.

6. The driver state determination system according to claim 4, wherein the predetermined first reference value and the predetermined second reference value are each calculated using values of the correction steering amount calculated at respective calculation times up to the current calculation time.

7. The driver state determination system according to claim 1, further comprising warning means for providing warning information to the driver based on a result of determination by said driver state determination means when the state of vigilance of the driver is low.

8. The driver state determination system according to claim 2, further comprising warning means for providing warning information to the driver based on a result of determination by said driver state determination means when the state of vigilance of the driver is low.

9. The driver state determination system according to claim 3, further comprising warning means for providing warning information to the driver based on a result of determination by said driver state determination means when the state of vigilance of the driver is low.

10. The driver state determination system according to claim 4, further comprising warning means for providing warning information to the driver based on a result of determination by said driver state determination means when the state of vigilance of the driver is low.
